(19) United States
(12) Patent Application Publication
(10) Pub. No.: US 2004/0218225 A1
(43) Pub. Date: Nov. 4, 2004

(54) Network facsimile and method of operating the same

(76) Inventor: Young-hoon Kim, Yongin-si (KR)

Correspondence Address: STANZIONE & KIM, LLP, 1740 N STREET, N.W., FIRST FLOOR, WASHINGTON, DC, 20036, US

(21) Appl. No.: 10/750,769

(22) Filed: Jan. 5, 2004

(30) Foreign Application Priority Data
May 2, 2003 (KR) 2003-28169

(51) Int. Cl. H04N 1/00; H04N 1/46

(52) U.S. Cl. 358/400; 358/500

(57) ABSTRACT

A network facsimile and an network facsimile operation method include storing received facsimile data until an amount of the received facsimile data is more than a predetermined amount if the facsimile data corresponding to a facsimile document is received from an outside source when there is no printing paper on which the facsimile data is to be printed; converting and transmitting the stored facsimile data into a form of an electronic mail to the mail server, if the amount of the received facsimile data is more than the predetermined amount or if the facsimile data is completely received; and determining whether the facsimile data is completely received, and proceeding to the operation of storing the received facsimile data if the facsimile data is not completely received. Therefore, it is possible to prevent the received facsimile document from being lost, regardless of the received amount of the facsimile data and a storage space, by receiving and simultaneously dividing a large amount of the facsimile data into the form of the electronic mail when there is no printing paper or the storage space is limited, and then receiving and displaying the facsimile data from a designated mail address to a user when printing paper is newly supplied.

### CROSS-REFERENCE TO RELATED APPLICATIONS

This application claims the priority of Korean Patent Application No. 2003-28169, filed on May 2, 2003, in the Korean Intellectual Property Office, the disclosure of which is incorporated herein in its entirety by reference.

### BACKGROUND OF THE INVENTION

1. Field of the Invention

The present invention relates to a network facsimile to perform both a function of transmitting and/or receiving electronic mails and a facsimile function, and more particularly, to a network facsimile and a method of operating the same.

2. Description of the Related Art

Hereinafter, a method of operating a conventional network facsimile will be described.

A network facsimile is an internet facsimile capable of receiving images via a telephone line and transmitting the received images via a network. A conventional network facsimile converts facsimile data stored in a memory into the form of an electronic mail and transmits the converted electronic mail to a designated electronic mail address in a case where a memory space to store the facsimile data corresponding to a facsimile document to be received later is scarce or no printing paper exists in the network facsimile. Thereafter, if printing paper is newly supplied to the network facsimile and the memory space is sufficient, the network facsimile gets and prints the electronic mail transmitted to the designated electronic mail address.

The conventional network facsimile determines whether there is no printing paper or whether the memory space is scarce, before receiving any facsimile data, and manages the memory according to the determined result. Accordingly, a problem exists in that the conventional network facsimile can miss (lose) the received facsimile data in a case where the printing paper is no longer supplied or the memory space to store the received facsimile data becomes scarce when a large amount of the facsimile data is received.

### SUMMARY OF THE INVENTION

Accordingly, it is an aspect of the present invention to provide a network facsimile operation method of receiving and providing a large amount of facsimile documents to a user without any loss thereof even in a case where no printing paper is supplied to print at least one facsimile document or a storage space to store the facsimile document is limited.

It is another aspect of the present invention to provide a network facsimile capable of receiving and providing a large amount of facsimile documents to a user without any loss thereof even in a case where no printing paper is supplied or a storage space is limited.

Additional aspects and/or advantages of the invention will be set forth in part in the description which follows and, in part, will be obvious from the description, or may be learned by practice of the invention.

The foregoing and/or other aspects of the present invention are achieved by providing a method of operating a network facsimile, the network facsimile performing both a function of transmitting and/or receiving an electronic mail to and/or from a mail server and a facsimile function, the method comprising: storing facsimile data received from an outside source until an amount of the received facsimile data is more than a predetermined amount if the facsimile data is received from the outside source when there is no printing paper on which the facsimile data is to be printed; converting the stored facsimile data into the form of an electronic mail and transmitting the converted data to the mail server if the amount of the received facsimile data is more than the predetermined amount or if the facsimile data is completely received; and determining whether the facsimile data is completely received, and proceeding to the storing operation if the facsimile data is not completely received.

The foregoing and/or other aspects of the present invention are also achieved by providing a network facsimile performing both a function of transmitting and/or receiving an electronic mail to and/or from a mail server and a facsimile function, the network facsimile comprising: a data receiving processor, which checks whether printing paper to print facsimile data provided from an outside source exists, whether the facsimile data is received, whether an amount of the received facsimile data is more than a predetermined amount, and whether the facsimile data is completely received, receives and stores the facsimile data in response to first, second, third, and fourth control signals corresponding to the checked results, respectively, and outputs the stored facsimile data in response to one of the third and the fourth control signal; and a data transmitting processor, which converts the stored facsimile data received from the data receiving processor into the form of an electronic mail and transmits the converted data to the mail server.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a flow chart illustrating a method of operating a network facsimile according to an embodiment of the present invention;

FIG. 2 is a flow chart illustrating a method of performing operation 10 shown in FIG. 1 according to another embodiment of the present invention;

FIG. 3 is a flow chart illustrating a method of performing operation 26 shown in FIG. 2 according to another embodiment of the present invention;

FIG. 4 is a flow chart illustrating another method of performing operation 26 shown in FIG. 2 according to another embodiment of the present invention;

FIG. 5 is a flow chart illustrating a method of performing operation 12 shown in FIG. 1 according to another embodiment of the present invention;

FIG. 6 is a flow chart illustrating a method of operating a network facsimile according to another embodiment of the present invention;

FIG. 7 is a flow chart illustrating a method of performing operation 106 shown in FIG. 6 according to another embodiment of the present invention;

FIG. 8 is a block diagram of a network facsimile according to another embodiment of the present invention;

FIG. 9 is a block diagram of a data receiving processor of the network facsimile shown in FIG. 8 according to another embodiment of the present invention;

FIG. 10 is a block diagram of a data management unit of the data receiving processor shown in FIG. 9 according to another embodiment of the present invention;

FIG. 11 is a block diagram of another data management unit of the data receiving processor shown in FIG. 9 according to another embodiment of the present invention;

FIG. 12 is a block diagram of a data transmitting processor of the network facsimile shown in FIG. 8 according to another embodiment of the present invention;

FIG. 13 is a block diagram of a network facsimile according to another embodiment of the present invention;

FIG. 14 is a block diagram of a mail receiving and displaying unit of the network facsimile shown in FIG. 13 according to another embodiment of the present invention;

FIGS. 15-17 show forms of electronic mails to be divided and transmitted in the network facsimile shown in FIGS. 8 and 13; and

FIG. 18 shows examples of electronic mails stored in a mail server connected to the network facsimile shown in FIGS. 8 and 13.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments of a network facsimile and a network facsimile operation method are described below in order to explain the present invention by referring to the figures.

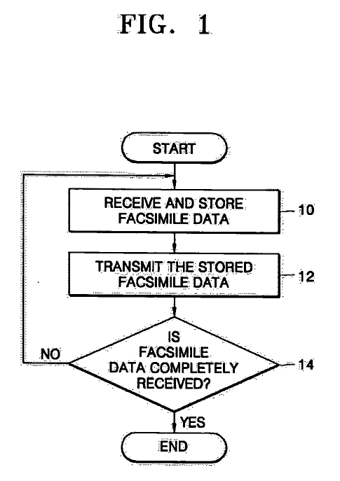

FIG. 1 is a flow chart illustrating a method of operating a network facsimile according to an embodiment of the present invention, wherein the operation method comprises receiving and storing facsimile data corresponding to a facsimile document and transmitting the stored facsimile data in operations 10 through 14. The facsimile document includes at least one page document (image) and may include more than two page documents (images).

The network facsimile has a function to transmit and/or receive electronic mails to and/or from a mail server (not shown) as well as a facsimile function. For example, the network facsimile (not shown) can transmit and/or receive the facsimile data to and/or from a general facsimile (not shown) and can transmit and/or receive the facsimile data in the form of an electronic mail to and/or from the mail server through a telephone line or a wireless communication apparatus. Here, the mail server can be implemented by first and second servers. The first server receives the electronic mail including the facsimile data from the network facsimile and provides the same to the second server. The second server provides the electronic mail including the facsimile data received from the first server to another server or to the network facsimile. For this purpose, the first server may be a Simple Mail Transfer Protocol (SMTP) server, and the second server may be a Post Office Protocol (POP) 3 server or an Internet Message Access Protocol (IMAP) 4 server.

According to the network facsimile operation method of the present invention, if the facsimile data corresponding to the facsimile document is received from an outside source while no printing paper exists, the received facsimile data is stored until the amount of received facsimile data reaches a predetermined amount in operation 10. At this time, there can be a case where there is no printing paper while the facsimile data is being received or before the facsimile data is received.

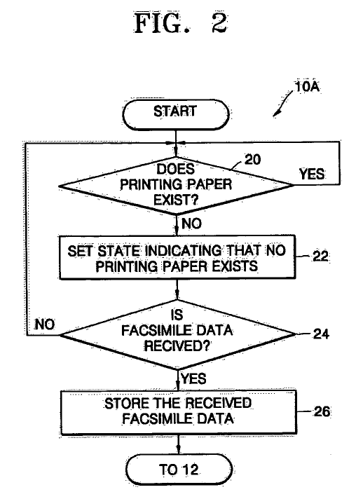

FIG. 2 is a flow chart illustrating a method (process) 10A of performing operation 10 shown in FIG. 1 according to another embodiment of the present invention, wherein the method comprises determining whether any facsimile data is received while there is no printing paper in operations 20 through 24 and storing the received facsimile data in operation 26.

Referring to FIG. 2, it is first determined whether there is printing paper in operation 20. If there is no printing paper, a state indicating that there is no printing paper is set in operation 22. After operation 22, it is determined whether the facsimile data is received in operation 24.

According to this embodiment of the present invention, operation 22 can be omitted from the process 10A shown in FIG. 2. In this case, if it is determined that there is no printing paper, it is determined whether facsimile data is received in operation 24. If it is determined that no facsimile data is received, the process proceeds to operation 20. However, if it is determined that the facsimile data is received, the received facsimile data is stored until the amount thereof reaches a predetermined amount. Then, the process proceeds to operation 12 of FIG. 1 in operation 26.

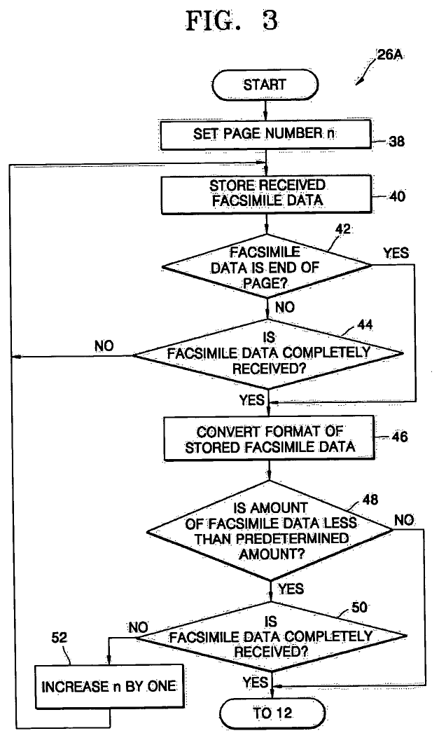

FIG. 3 is a flow chart illustrating a method (process) 26A of performing operation 26 shown in FIG. 2 according to another embodiment of the present invention, wherein the method comprises storing a non-converted format of the facsimile data in operations 38 through 40 and proceeding to operation 12 of FIG. 1 according to a comparison result of the amount of the facsimile data and the predetermined amount, if the facsimile data is an end of a page of the facsimile document or if the facsimile data is completely received in operations 42 through 52.

Referring to FIG. 3, if it is determined that the facsimile data is received in operation 24, a page number n of the facsimile data is set in operation 38. That is, the page number n is set to “one.” After operation 38 is performed, the received facsimile data is stored in operation 40. According to this embodiment of the present invention, operation 38 can be omitted from the process 26A shown in FIG. 3. In this case, if it is determined that the facsimile data is received in operation 24, the received facsimile data is stored in operation 40.

After operation 40 is performed, it is determined whether the currently received facsimile data is an end of each page of the facsimile document to be printed in operation 42. If it is determined that the received facsimile data is not the end of the page to be printed, it is determined whether the facsimile data is completely received in operation 44. Here, the determination that the facsimile data is completely received represents that the facsimile document transmitted from the outside source is completely received. If it is determined that the facsimile data is not completely received, the process proceeds to operation 40.

However, if it is determined that the currently received facsimile data is the end of each page of the facsimile document to be printed or if it is determined that the facsimile data is completely received, the format of the stored facsimile data is converted in operation 46. Here, the format of the stored facsimile data can be converted in a unit of a page, that is, the format of the stored facsimile data corresponding to each page of the facsimile document is converted in operation 46.

After operation 46 is performed, it is determined whether the amount of the converted format of the facsimile data is less than a predetermined amount in operation 48.

According to this embodiment of the present invention, operation 46 can be omitted from the process 26A shown in FIG. 3. In this case, if it is determined that the facsimile data is the end of the page of the facsimile document or if it is determined that the facsimile data is completely received, it is determined whether the amount of the stored facsimile data with a non-converted format, instead of the converted format, is less than the predetermined amount in operation 48.

If it is determined that the amount of the stored facsimile data is less than the predetermined amount, it is determined whether the facsimile data is completely received in operation 50. At this time, if it is determined that the facsimile data is not completely received, the page number n is increased by one and the process proceeds to operation 40 in operation 52. However, if it is determined that the amount of the stored facsimile data is more than the predetermined amount or if it is determined that the facsimile data is completely received, the process 26A proceeds to operation 12 of FIG. 1.

As described above, if operation 38 is omitted from the process 26A shown in FIG. 3, operation 52 is may also be omitted. In this case, if it is determined that the facsimile data is not completely received in operation 50, the process proceeds to operation 40.

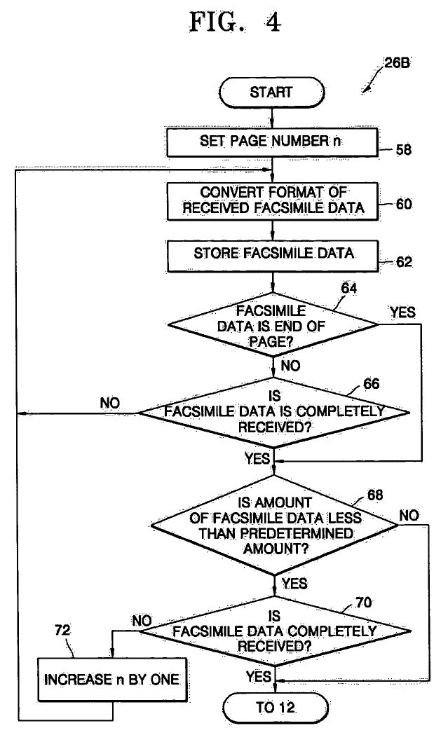

FIG. 4 is a flow chart illustrating a method (process) 26B of performing operation 26 shown in FIG. 2 according to another embodiment of the present invention, wherein the method comprises storing a converted format of the facsimile data in operations 58 through 62 and proceeding to operation 12 according to a comparison result of the amount of the converted format of the facsimile data and the predetermined amount, if the facsimile data is the end of the page of the facsimile document or if the facsimile data is completely received in operation 64 through 72.

Referring to FIG. 4, if it is determined that the facsimile data is received in operation 24, a page number n of the facsimile data is set in operation 58. After operation 58 is performed, the format of the received facsimile data is converted in operation 60.

In operation 46 shown in FIG. 3 or in operation 60 shown in FIG. 4, for example, the format of the received facsimile data can be converted into a Tagged Image File Format (TIFF).

According to the present invention, operation 58 can be omitted from the process 26B shown in FIG. 4. In this case, if it is determined that the facsimile data is received in operation 24, the format of the received facsimile data is converted in operation 60.

Meanwhile, after operation 60 is performed, the converted format of the facsimile data, for example, the TIFF, is stored in operation 62. After operation 62 is performed, it is determined whether the currently received facsimile data is the end of the page to be printed in operation 64. In operation 42 shown in FIG. 3 or in operation 64 shown in FIG. 4, for example, it can be determined whether the received facsimile data is the end of the page to be printed, using a related protocol, for example, an End Of Page (EOP) command indicating an end of a page.

If it is determined that the facsimile data is not the end of the page to be printed, it is determined whether the facsimile data is completely received in operation 66. If it is determined that the facsimile data is not completely received, the process proceeds to operation 60.

However, if the facsimile data is the end of the page or if the facsimile data is completely received, then it is determined whether the amount of the stored facsimile data with the converted format is less than a predetermined amount in operation 68.

If the amount of the stored facsimile data with the converted format is less than the predetermined amount, it is determined whether the facsimile data is completely received in operation 70. If the facsimile data is not completely received, the page number n is increased by one and the process proceeds to operation 60.

If it is determined that the amount of the stored facsimile data is more than the predetermined amount or if it is determined that the facsimile data is completely received, the process 26B proceeds to operation 12.

As described above, according to the present invention, if operation 58 is omitted from the process 26B shown in FIG. 4, operation 72 is also omitted. In this case, if it is determined that the facsimile data is not completely received in operation 70, the process proceeds to operation 60.

In the process 26A of FIG. 3 the format of the stored facsimile data is converted if it is determined that the facsimile data is the end of the page in operation 42, or if it is determined that the facsimile data is completely received in operation 44. Contrary to the process 26A shown in FIG. 3, operation 46 is performed to convert the format of the stored facsimile data, and then the process 26A proceeds to operation 12 if it is determined that the amount of the facsimile data is more than a predetermined amount in operation 48 or if it is determined that the facsimile data is completely received in operation 50. In this case, if it is determined that the facsimile data is the end of the page in operation 42 or if it is determined that the facsimile data is completely received in operation 44, it is determined whether the amount of the facsimile data stored in operation 40 is less than the predetermined amount in operation 48.

Similarly, contrary to operations of the process 26B of FIG. 4 in which operation 60 is performed after operation 58, the format of the received facsimile data can be converted if it is determined that the amount of the facsimile data is more than the predetermined amount in operation 68 or if it is determined that the facsimile data is completely received in operation 70. In this case, the non-converted format of the facsimile data is stored in operation 62, instead of performing operation 60 after operation 58 is performed. Accordingly, the facsimile data having the non-converted format is compared with the predetermined amount.

Meanwhile, after operation 10, if the amount of the received facsimile data is more than the predetermined amount or if the facsimile data is completely received, the stored facsimile data is converted into the form of an electronic mail and transmitted to a pre-designated mail server in operation 12.

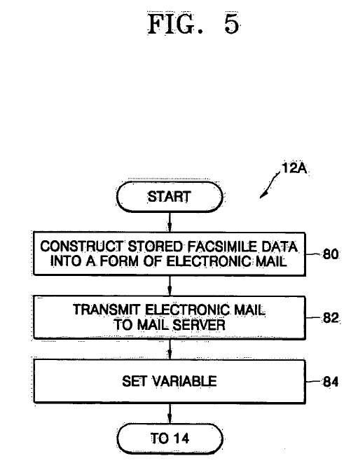

FIG. 5 is a flow chart illustrating a method (process) 12A of performing operation 12 shown in FIG. 1 according to another embodiment of the present invention, wherein the method comprises converting the stored facsimile data into a form of an electronic mail and transmitting the electronic mail in operation 80 through 82 and setting a variable in operation 84.

Referring to FIGS. 1 through 5, if it is determined that the amount of the received facsimile data is more than the predetermined amount in operation 48 or 68 shown respectively in FIG. 3 or 4, or if it is determined that the facsimile data is completely received in operation 50 or 70, the stored facsimile data is converted into the form of the electronic mail in operation 80. The facsimile data can be constructed as an attachment of the electronic mail in operation 80. Also, in a case where the process 26A shown in FIG. 3 includes operations 38 and 52, or the process 26B shown in FIG. 4 includes operations 58 and 72, the form of the electronic mail is constructed according to a set page number or an increased page number n. At this time, according to the present invention, an identification factor to identify the facsimile data corresponding to the facsimile document from different facsimile data corresponding to a different facsimile document can be included in the electronic mail in operation 80. Domain names or IP addresses of first and second servers, users' addresses, passwords, electronic mail addresses, etc., required to construct the electronic mail, can be preset in the network facsimile. Also, the identification factor can be included in a standard header, a non-standard header, or a title of the electronic mail.

After operation 82 is performed, the facsimile data converted into the form of the electronic mail is transmitted to a mail server in operation 82. Here, the mail server may be the first server.

After operation 82 is performed, a variable indicating that the facsimile data is converted into the form of the electronic mail and transmitted to the mail server is set in operation 84.

Meanwhile, after operation 12 is performed, it is determined whether the facsimile data is completely received in operation 14. If the facsimile data is not completely received, the process 12A proceeds to operation 10. However, if it is determined that the facsimile data is completely received, the network facsimile operation method shown in FIG. 1 is terminated.

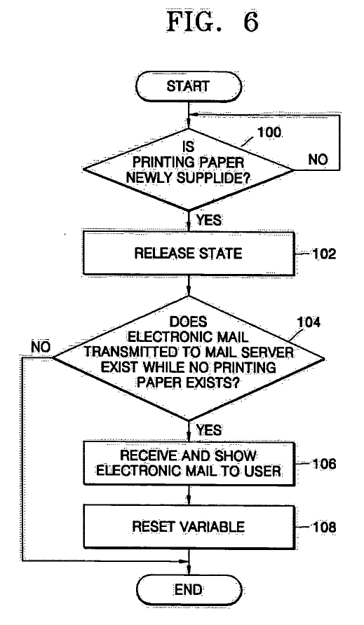

FIG. 6 is a flow chart illustrating another method of operating a network facsimile according to another embodiment of the present invention, wherein the network facsimile operation method comprises receiving an electronic mail transmitted to a main server and displaying the received electronic mail to a user when printing paper is newly supplied in operations 100 through 108.

The operations 100 through 108 shown in FIG. 6 can be performed in the network facsimile performing the network facsimile operation method shown in FIG. 1. In this case, if it is determined that there is the printing paper in operation 20 of FIG. 2, the operation method shown in FIG. 6 is performed.

Referring to FIGS. 1-6, it is determined whether the printing paper is newly supplied in operation 100 after it is determined that there is no printing paper. For example, as shown in FIG. 2, it is assumed that the process of the method 10A includes operation 22. That is, it is assumed that a state indicating that there is no printing paper is set in operation 22, when there is no printing paper. At this time, if it is determined that there is printing paper, it is determined whether the state is set in operation 100. For example, if the state is set when it is determined that there is printing paper, it represents that printing paper has newly been supplied. However, if the state is not set when it is determined that there is printing paper, it represents that there has continuously been printing paper. In this case, the received facsimile data is printed according to a conventional facsimile function of the network facsimile.

If it is determined that printing paper is newly supplied, that is, if the state is set when it is determined that there is printing paper, the state indicating that there is no printing paper is released in operation 102. After operation 102 is performed, while there is no printing paper, it is determined whether an electronic mail has been transmitted to the mail server in operation 104. That is, it is determined whether the electronic mail transmitted to the mail server without being yet displayed to a user exists since no printing paper exists.

According to the present invention, operation 102 can be omitted from the operation method shown in FIG. 6. In this case, if it is determined that printing paper is newly supplied, it is determined whether an electronic mail transmitted to the mail server exists when no printing paper, exists in operation 104. If no electronic mail transmitted to the mail server exists when no printing paper exists, the network facsimile operation method shown in FIG. 6 is terminated. However, if it is determined that the electronic mail transmitted to the mail server exists while no printing paper exists, the corresponding electronic mail is received from the mail server and shown to the user in operation 106. Here, the electronic mail can be shown to the user using a screen of a monitor or the printing paper, etc. At this time, the electronic mail can be received from the second server of the mail server. The electronic mail received in operation 106 may be another electronic mail other than the electronic mail transmitted to the mail server when there is no printing paper. Here, it can be determined through the identification factor whether the received electronic mail is the electronic mail transmitted to the mail server when there is no printing paper or another electronic mail.

According to an aspect of the present invention, in a case where the process 12A of FIG. 5 includes operation 84 as described above, it can be determined whether the variable is set in order to determine whether the electronic mail has been transmitted to the mail server when there is no printing paper. If any electronic mail is transmitted to the mail server, the variable is set. Accordingly, if the variable is set, the electronic mail is received from the mail server and shown to the user in operation 106. After all the electronic mails are shown to the user, the variable is reset in operation 108.

According to another aspect of the present invention, in a case where the process 12A of FIG. 5 does not include operation 84, a search for the mail server is performed in order to determine whether the electronic mail has been transmitted to the mail server when there is no printing paper. In this case, the operation method shown in FIG. 6 does not include operation 108.

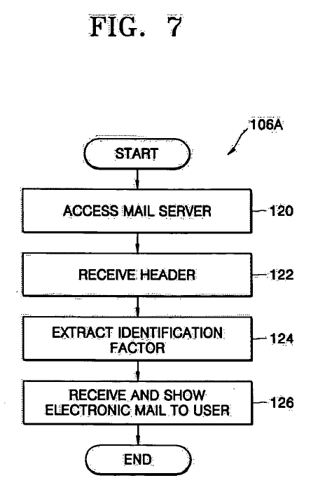

FIG. 7 is a flow chart illustrating a method (process) 106A of performing operation 106 shown in FIG. 6 according to another embodiment of the present invention, wherein the method comprises accessing a mail server and receiving a header in operations 120 through 122 and receiving and displaying a corresponding electronic mail using an extracted result of an identification factor to a user in operations 124 through 126.

Referring to FIGS. 1-7, if it is determined that an electronic mail transmitted to the mail server exists, the network facsimile accesses the mail server in operation 120. After operation 120, the network facsimile receives the header from the accessed mail server in operation 122. After operation 122, the identification factor is extracted from the header in operation 124. After operation 124, the electronic mail corresponding to the facsimile document divided into the page unit and transmitted to the mail server is received from the mail server among a plurality of electronic mails included in the mail server, using the extracted identification factor in operation 126. The received electronic mail is displayed to the user in operation 126.

Hereinafter, the construction and operations of a network facsimile according to an aspect of the present invention will be described in detail with reference to the appended drawings.

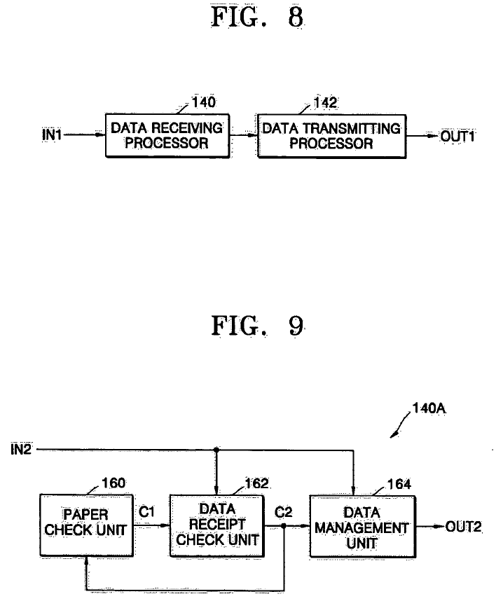

FIG. 8 is a block diagram of a network facsimile according to another embodiment of the present invention, wherein the network facsimile comprises a data receiving processor 140 and a data transmitting processor 142.

The network facsimile shown in FIG. 8 performs the operation method shown in FIG. 1.

First, the data receiving processor 140 performs operations 10 through 14 shown in FIG. 1. First, to perform operation 10 of FIG. 1, the data receiving processor 14Q checks whether there is printing paper to print the facsimile data, whether any facsimile data is received, and whether an amount of the received facsimile data is more than a predetermined amount. Then, the data receiving processor 140 receives and stores the facsimile data through an input terminal IN1, in response to first, second, and third control signals C1, C2, and C3 corresponding to the above checked results, respectively. The data receiving processor 140 outputs the stored facsimile data to the data transmitting processor 142 in response to the third control signal C3. Next, to perform operation 14, the data receiving processor 140 checks whether the facsimile data is completely received and generates the checked result as a fourth control signal C4. In this case, the data receiving processor 140 receives and stores the facsimile data through the input terminal IN1 in response to the fourth control signal C4, or outputs the stored facsimile data to the data transmitting processor 142.

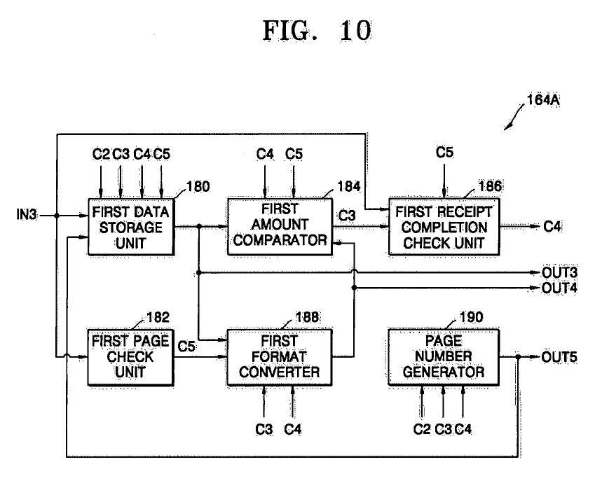

FIG. 9 is a block diagram of another data receiving processor 140A corresponding to the data receiving process 140 shown in FIG. 8 according to another embodiment of the present invention, wherein the data receiving processor 140 comprises a paper check unit 160, a data receipt check unit 162, and a data management unit 164.

The data receiving processor 140A shown in FIG. 9 performs operations 20, 24, and 26 in the process 10A shown in FIG. 2.

To perform operation 20, the paper check unit 160 of the data receiving processor 140A checks whether there is printing paper, in response to the second control signal C2 received from the data receipt check unit 162, and outputs the checked result as the first control signal C1 to the data receipt check unit 162.

To perform operation 24, the data receipt check unit 162 checks whether the facsimile data is received through an input terminal IN2, in response to the first control signal C1 received from the paper check unit 160, and outputs the checked result as the second control signal C2 to the paper check unit 160 and the data management unit 164. For example, if it is determined by the first control signal C1 that there is no printing paper, the data receipt check unit 162 checks whether the facsimile data is received. If it is determined through the second control signal C2 that the facsimile data is not received, the paper check unit 160 again checks whether there is the printing paper.

To perform operation 26, the data management unit 164 stores and manages the facsimile data received through the input terminal IN2 in response to the second control signal C2 received from the data receipt check unit 162. For example, if it is determined by the second control signal C2 that the facsimile data is received, the data management unit 164 stores and manages the facsimile data received through the input terminal IN2.

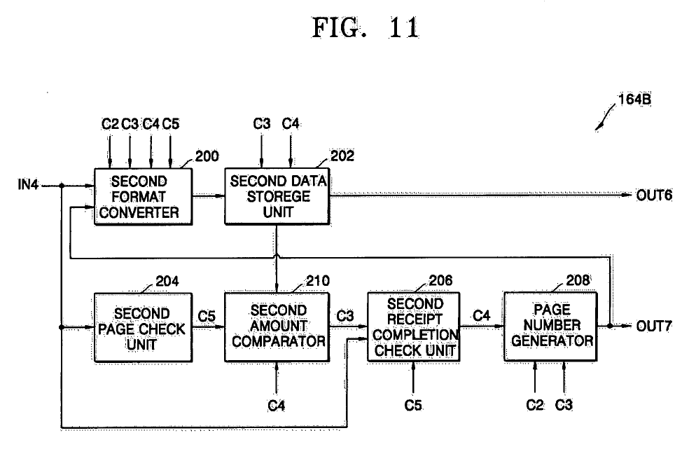

FIG. 10 is a block diagram of another data management unit 164A corresponding to the data management unit 164 shown in FIG. 9 according to another embodiment of the present invention, wherein the data management unit 1.64A comprises a first data storage unit 180, a first page check unit 182, a first amount comparator 184, a first receipt completion check unit 186, a first format converter 188, and a page number generator 190.

The data management unit 164A shown in FIG. 10 performs the process 26A shown in FIG. 3.

To perform operation 38, the page number generator 190 of the data management unit 164A sets a page number n of the facsimile data in response to the second control signal C2 received from the data receipt check unit 162. For example, if it is determined by the second control signal C2 that the facsimile data is received, the page number generator 190 sets the page number n and outputs the set page number n through an output terminal OUT5 to the first data storage unit 180. Also, to perform operation 52, the page number generator 190 increases the page number n by one, in response to the third control signal C3 received from the first amount comparator 184 and the fourth control signal C4 received from the first receipt completion check unit 186, and outputs the increased page number through an output terminal OUT5 to the first data storage unit 180. For example, if it is determined by the third control signal C3 that the amount of the facsimile data is less than the predetermined amount and when it is determined by the fourth control signal C4 that the facsimile data is not completely received, the page number generator 190 increases the page number n by one.

According to an aspect of the present invention, as described above, in a case where the process of the method 26A shown in FIG. 3 includes operations 38 and 52, to perform operation 40, the first data storage unit 180 receives and stores the facsimile data through the input terminal IN3 when the set page number or the increased page number is received from the page number generator 190.

According to another aspect of the present invention, in a case where the process 26A shown in FIG. 3 does not include operations 38 and 52, the data management unit 164A shown in FIG. 10 does not include the page number generator 190. In this case, to perform operation 40, the first data storage unit 180 stores the facsimile data received through the input terminal IN3 in response to the second control signal C2 or the fourth control signal C4. For example, if it is determined by the second control signal C2 that the facsimile data is received in operation 24, or if it is determined by the fourth control signal C4 that the facsimile data is not completely received in operation 50, the first data storage unit 180 receives and stores the facsimile data through the input terminal IN3.

Also, to perform operation 40, regardless of whether the data management unit 164A shown in FIG. 10 includes the page number generator 190, the first data storage unit 180 stores the facsimile data received through the input terminal IN3 in response to the fourth control signal C4 and a fifth control signal C5. For example, if it is determined by the fourth and the fifth control signals C4 and C5 that the facsimile data is not the end of the page of the facsimile document and the facsimile data is not completely received according to operations 42 and 44, respectively, the first data storage unit 180 stores the facsimile data received through the input terminal IN3.

Also, the first data storage unit 180 reads the stored facsimile data and sent through the output terminal OUT3 in response to the third or fourth control signal C3 or C4. That is, in a case where the data management unit 164A shown in FIG. 10 does not include the first format converter 188, if it is determined by the third control signal C3 that the amount of the facsimile data is more than the predetermined amount, the first data storage unit 180 outputs the stored facsimile data to the data transmitting processor 142 through the output terminal OUT3. Also, if it is determined by the fourth control signal C4 that the facsimile data is completely received in operation 50, the first data storage unit 180 outputs the stored facsimile data through the output terminal OUT3.

To perform operation 42 shown in FIG. 3, the first page check unit 182 checks whether the facsimile data input through the input terminal IN3 corresponds to the end of each page of the facsimile document to be printed, and outputs the checked result as the fifth control signal C5 to the first data storage unit 180, the first receiving completion check unit 186, and the first format converter 188.

To perform operation 44, the first receipt completion check unit 186 checks whether the facsimile data received through the input terminal IN3 is completely received, in response to the fifth control signal C5 received from the first page check unit 182, and outputs the checked result as the fourth control signal C4 to the first data storage unit 180, the first format converter 188, and the page number generator 190. For example, if it is determined by the fifth control signal C5 that the facsimile data is not the end of the page, the first receipt completion check unit 186 checks whether the facsimile data is completely received. Also, to perform operation 50, the first receipt completion check unit 186 checks whether the facsimile data is completely received, in response to the third control signal C3. For example, if it is determined by the third control signal C3 that the amount of the facsimile data is less than the predetermined amount, the first receipt completion check unit 186 checks whether the facsimile data is completely received through the input terminal IN3.

To perform operation 46, the first format converter 188 converts a format of the stored facsimile data received from the first data storage unit 180 in response to the fifth control signal C5 received from the first page check unit 182 or the fourth control signal C4 received from the first receipt completion check unit 186, and outputs the converted format of the facsimile data to the first amount comparator 184. For example, if it is determined by the fifth control signal C5 that the facsimile data is the end of the page in operation 42 or by the fourth control signal C4 that the facsimile data is completely received in operation 44, the first format converter 188 converts the format of the stored facsimile data received from the first data storage unit 180. At this time, the first format converter 188 outputs the converted format of the facsimile data to the data transmitting processor 142 through the output terminal OUT4 in response to the third and fourth control signals C3 and C4. For example, if it is determined by the third control signal C3 that the amount of the facsimile data is more than the predetermined amount, or by the third and fourth control signals C3 and C4 that the amount of the facsimile data is less than predetermined amount but the facsimile data is completely received, the first format converter 188 outputs the converted format of the facsimile data to the data transmitting processor 142 through the output terminal OUT4.

To perform operation 48, the first amount comparator 184 compares the amount of the stored facsimile data of the converted format received from the first format converter 188 with the predetermined amount, and outputs the comparison result as the third control signal C3 to the first data storage unit 180, the first receipt completion check unit 186, and the first format converter 188, respectively.

As described above, in a case where process 26A shown in FIG. 3 does not include step 46, the first amount converter 184 compares the amount of the stored facsimile data received from the first data storage unit 180 with the predetermined amount, in response to the fourth and the fifth control signals C4 and C5, and outputs the comparison result as the third control signal C3. For example, if it is determined by the fourth control signal C4 that the facsimile data is completely received, or by the fifth control signal C5 that the facsimile data is the end of the page, the first amount comparator 184 compares the amount of the stored facsimile data with the predetermined amount.

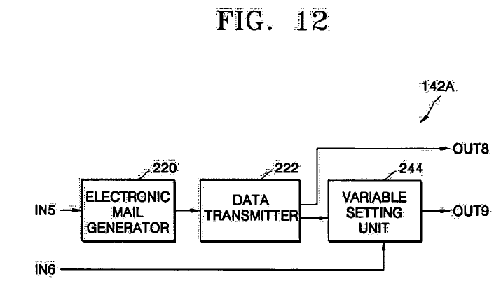

FIG. 11 is a block diagram of another data management unit 164B corresponding to the data management unit 164 shown in FIG. 9 according to another embodiment of the present invention, wherein the data management unit 164B comprises a second format converter 200, a second data storage unit 202, a second page check unit 204, a second receipt completion check unit 206, a page number generator 208, and a second amount comparator 210.

The data management unit 164B shown in FIG. 11 performs to process 26B shown in FIG. 4.

To perform operation 58, the page number generator 208 of the data management unit 164B sets a page number n of the facsimile data in response to the second control signal C2 received from the data receipt check unit 162. For example, if it is determined by the second control signal C2 that the facsimile data is received, the page number generator 208 sets the page number n, and outputs the set page number n through an output terminal OUT7 to the second format converter 200. Also, to perform operation 72, the page number generator 208 increases the page number n by one in response to the third control signal C3 received from the second amount comparator 210 and the fourth control signal C4 received from the second receipt completion check unit 206, and outputs the increased page number through the output terminal OUT7. For example, when it is determined by the third control signal C3 that the amount of the facsimile data is less than the predetermined amount and if it is determined by the fourth control signal C4 that the facsimile data is not completely received, the page number generator 208 increases the page number n by one.

According to an aspect of the present invention, as described above, in a case where the process 26B shown in FIG. 4 includes operations 58 and 72, to perform operations 60, the second format converter 200 converts the format of the facsimile data received through the input terminal IN4 when the set page number or the page number increased by one is received from the page number generator 208, and outputs the converted format of the facsimile data to the second data storage unit 202.

According to another aspect of the present invention, in a case where the process 26B shown in FIG. 4 does not include operations 58 and 72, the data management unit 164B shown in FIG. 11 does not include the page number generator 208. To perform operations 60, the second format converter 200 converts the format of the facsimile data received through the input terminal IN4 in response to the second control signal C2 or the third and fourth control signals C3 and C4. For example, if it is determined that the facsimile data is not completely received, when it is determined by the second control signal C2 that the facsimile data is received or by the third and fourth control signals C3 and C4 that the amount of the facsimile data is less than the predetermined amount, the second format converter 200 converts the format of the facsimile data received through the input terminal IN4.

Also, to perform operation 60 regardless of whether the data management unit 164B includes the page number generator 208, the second format converter 200 converts the format of the facsimile data received through the input terminal IN4 in response to the fourth and fifth control signals C4 and C5. For example, if it is determined by the fourth and fifth control signals C4 and C5 that the facsimile data is not the end of the page and the facsimile data is not completely received, the second format converter 200 converts the format of the facsimile data.

To perform operation 62, the second data storage unit 202 stores the converted format of the facsimile data received from the second format converter 200. Also, the second data storage unit 202 reads and transmits the stored facsimile data to the data transmitting processor 142 shown in FIG. 8 through the output terminal OUT6 in response to the third or fourth control signal C3 or C4. That is, if it is determined by the third control signal C3 received from the second amount comparator 210 that the amount of the facsimile data is more than the predetermined amount, the second data storage unit 202 outputs the stored facsimile data through the output terminal OUT6. If it is determined by the fourth control signal C4 received from the second receipt completion check unit 206 that the facsimile data is completely received, the second data storage unit 202 outputs the facsimile data through the output terminal OUT6.

At this time, the first data storage unit 180 shown in FIG. 10 and the second data storage unit 202 shown in FIG. 11 may be Dynamic Random Access Memories (DRAMs). Here, the first or second data storage unit 180 or 202 reads the storing facsimile data and then removes the stored facsimile data in order to store the following received facsimile data.

To perform operation 64 shown in FIG. 4, the second page check unit 204 checks whether the facsimile data received through the input terminal IN4 corresponds to the end of each page of the facsimile document to be printed, and outputs the checked result as the fifth control signal C5 to the second format converter 200, the second receipt completion checker 206, and the second amount comparator 210.

To perform operation 66, the second receipt completion check unit 206 checks whether the facsimile data is completely received through the input terminal IN4, in response to the fifth control signal C5 received from the second page check unit 204, and outputs the checked result as the fourth control signal C4. For example, if it is determined by the fifth control signal C5 that the facsimile data does not correspond to the end of the page, the second receipt completion checker 206 checks whether the facsimile data is completely received. Also, to perform operation 70, the second receipt completion check unit 206 checks whether the facsimile data is completely received, in response to the third control signal C3, and outputs the checked result as the fourth control signal C4. For example, if it is determined by the third control signal C3 that the amount of the facsimile data is less than the predetermined amount, the second receipt completion check unit 206 checks whether the facsimile data is completely received through the input terminal IN4.

To perform operation 68, the second amount comparator 210 compares the amount of the stored facsimile data having the converted received from the second data storage unit 202 with the predetermined amount in response to the fourth and fifth control signals C4 and C5 or only the fifth control signal C5, and outputs the comparison result as the third control signal C3 to the second format converter 200, the second data storage unit 202, the second receipt completion check unit 206, and the page number generator 208. For example, if it is determined by the fourth and fifth control signals C4 and C5 that the facsimile data is not completely received when the facsimile data is not the end of the page, or by the fifth control signal C5 that the facsimile data is the end of the page, the second amount comparator 210 compares the amount of the facsimile data received from the second data storage unit 202 with the predetermined amount.

Meanwhile, to perform operation 12 shown in FIG. 1, the data transmitting processor 142 shown in FIG. 8 converts the stored facsimile data received from the data receiving processor 140 into the form of the electronic mail, and transmits the electronic mail to the mail server through the output terminal OUT1. At this time, in a case where the data management unit 164A or 164B shown in FIG. 10 or FIG. 11 includes the page number generator 190 or 208, the data transmitting processor 142 receives the page number output from the page number generator 190 or 208 through the output terminal OUT5 or OUT7, and constructs the electronic mail, according to the received page number.

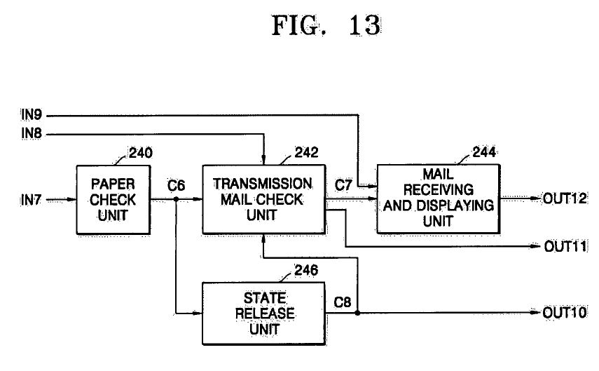

FIG. 12 is a block diagram of another data transmitting processor 142A corresponding to the data transmitting processor 142 shown in FIG. 8 according to another embodiment of the present invention, wherein the data transmitting processor 142A comprises an electronic mail generator 220, a data transmitter 222, and a variable setting unit 224.

The data transmitting processor 142A performs the process 12A shown in FIG. 5.

To perform operation 80, the electronic mail generator 220 of the data transmitting processor 142A converts the stored facsimile data received from the data receiving processor 140 through the input terminal IN5, into the form of the electronic mail, and outputs the electronic mail to the data transmitter 222. Here, the electronic mail generator 220 constructs the electronic mail including the identification factor to identify the facsimile data corresponding to the same facsimile document from another facsimile data later.

To perform operation 82, the data transmitter 222 transmits the facsimile data converted into the form of the electronic mail received from the electronic mail generator 220 to the mail server through the output terminal OUT8.

To perform operation 84, the variable setting unit 224 sets the variable indicating that the facsimile data as the form of the electronic mail is transmitted to the mail server, in response to a data transmission completion signal, and outputs the set variable through the output terminal OUT9. Here, the data transmission completion signal indicates whether the data transmitter 222 completely transmits data.

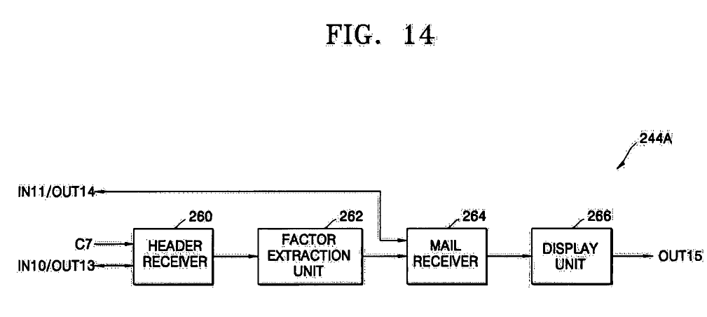

FIG. 13 is a block diagram of a network facsimile according to another embodiment of the present invention, wherein the network facsimile comprises a paper check unit 240, a transmission mail check unit 242, a mail receiving and displaying unit 244, and a state release unit 246.

The network facsimile shown in FIG. 13 performs the operation method shown in FIG. 6 and may be included in the network facsimile shown in FIG. 8.

To perform operation 100, the paper check unit 240 shown in FIG. 13 checks whether the printing paper is newly supplied after it is determined that no printing paper exists, and outputs the checked result as a sixth control signal C6 to the transmission mail check unit 242 and the state release unit 246.

For example, the data receiving processor 140 shown in FIG. 8 can generate a state signal indicating that no printing paper exists, when it is determined that no printing paper exists. At this time, the paper check unit 240 checks whether the state signal is received through the input terminal IN7, in response to the first control signal C1 received from the data receiving processor 140 through the input terminal IN7, and outputs the checked result as the sixth control signal C6. For example, if it is determined by the first control signal C1 that the printing paper exists, the paper check unit 240 checks whether the generated state signal is received.

Meanwhile, according to an aspect of the present invention as described above, if the operation method shown in FIG. 6 does not include operation 102, the network facsimile shown in FIG. 13 also does not include the state release unit 246. In this case, to perform operation 104, the transmission mail check unit 242 checks whether the electronic mail transmitted to the mail server exists when no printing paper exists, in response to the sixth control signal C6 received from the paper check unit 240, and outputs the checked result as a seventh control signal C7 to the mail receiving and displaying unit 244. For example, if it is determined by the sixth control signal C6 that the printing paper is newly supplied after it is determined that there is no printing paper, the transmission mail check unit 242 checks whether the electronic mail transmitted to the mail server exists.

According to another aspect of the present invention, in a case where the operation method shown in FIG. 6 includes operation 102, as shown in FIG. 13, the network facsimile includes the state release unit 246. To perform operation 102, the state release unit 246 generates an eighth control signal C8 to stop the generation of the state signal in response to the sixth control signal C6 received from the paper check unit 240. The state release unit 246 outputs the generated eighth control signal C8 to the transmission mail check unit 242 and simultaneously to the data receiving processor 140 through an output terminal OUT10. In this case, the data receiving processor 140 stops generating the state signal in response to the eighth control signal C8 received from the state release unit 246. The transmission mail check unit 242 checks whether the electronic mail transmitted to the mail server exists when it is determined that there is no printing paper, in response to the eighth control signal C8. For example, if it is determined by the eighth control signal C8 that the data receiving processor 140 attempts to stop generating the state signal, the transmission mail check unit 242 checks whether the electronic mail transmitted to the mail server exists.

Meanwhile, according to an aspect of the present invention, to perform operation 104, the transmission mail check unit 242 shown in FIG. 13 checks whether the variable received from the variable setting unit 224 is set, and can output the checked result as the seventh control signal C7. The data transmitting processor 142A shown in FIG. 12 includes the variable setting unit 224.

According to another aspect of the present invention, to perform operation 104, the transmission mail check unit 242 can search for the mail server and generate the seventh control signal C7. The transmitting mail check unit 242 sends the mail server through an output terminal OUT11 a query signal regarding whether there exists the electronic mail transmitted to the mail server when it is determined that there is no printing paper. At this time, the transmission mail check unit 242 receives information related to whether there is the electronic mail transmitted from the mail server, through the input terminal IN8.

Meanwhile, to perform operation 106 shown in FIG. 6, the mail receiving and displaying unit 244 receives the electronic mail from the mail server through the input terminal IN9 in response to the seventh control signal C7 received from the transmission mail check unit 242, and outputs the received electronic mail to the user through an output terminal OUT12. For example, if it is determined by the seventh control signal C7 that the transmitted electronic mail exists when it is determined that there is no printing paper, the mail receiving and displaying unit 244 receives and displays the electronic mail.

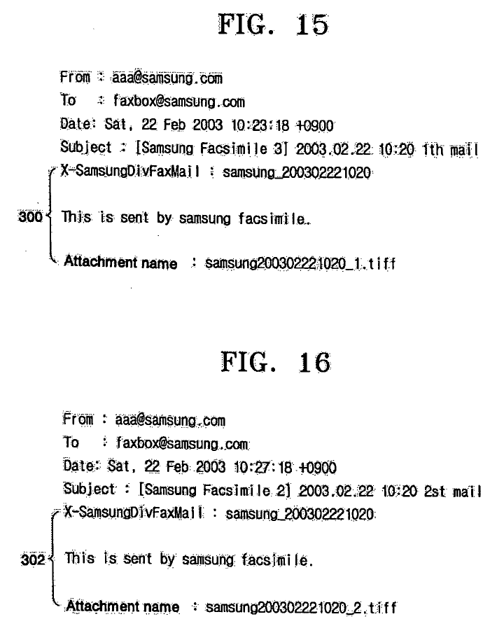

FIG. 14 is a block diagram of another mail receiving and displaying unit 244A corresponding to the mail receiving and displaying unit 244 shown in FIG. 13 according to another embodiment of the present invention, wherein the mail receiving and displaying unit 244A comprises a header receiver 260, a factor extraction unit 262, a mail receiver 264, and a display unit 266.

The mail receiving and displaying unit 244A shown in FIG. 14 performs the process 106A shown in FIG. 7.

To perform operation 120 and operation 122, the header receiver 260 of the mail receiving and displaying unit 244A accesses the mail server and receives a header, in response to the seventh control signal C7 received from the transmission mail check unit 242. For example, if it is determined by the seventh control signal C7 that an electronic mail transmitted to the mail server exists when it is determined that there is no printing paper, the header receiver 260 accesses the mail server and receives the header. For example, the header receiver 260 outputs an access request signal to the mail server through an output terminal OUT13, and receives an access authentication signal from the mail server through the input terminal IN10. After accessing the mail server, the header receiver 260 receives the header from the mail server through the input terminal IN10.

To perform operation 124, the factor extractor 262 extracts the identification factor from the header received from the header receiver 260, and outputs the extracted identification factor to the mail receiver 264.

To perform operation 126, the mail receiving and displaying unit 244A includes the mail receiver 264 and the display unit 266. The mail receiver 264 recognizes at least one electronic mail belonging to the same facsimile document divided and transmitted to the mail server using the identification factor extracted from the factor extractor 262, and receives the recognized electronic mail from the mail server through the input terminal IN11. The mail receiver 264 transmits information representing the recognized electronic mail to the mail server through an output terminal OUT14. The mail server reads only the electronic mail belonging to the same facsimile document corresponding to the information received from the mail receiver 264, and outputs it to the mail receiver 264. The display unit 266 shows the mail received from the mail receiver 264, to the user through an output terminal OUT15. For example, the display unit 266 shows the electronic mail to the user by displaying the electronic mail on a screen of a monitor or by printing the electronic mail on the printing paper.

To perform operation 108, the variable setting unit 224 of the data transmitting processor 142A resets the variable in response to a data display completion signal received from the mail receiving and displaying unit 244 through the input terminal IN6. For example, if it is determined by the display completion received from the mail receiving and displaying unit 244 that the mail is received and displayed, the variable setting unit 224 resets the variable.

Hereinafter, for convenience of descriptions, assuming that the network facsimile can store the amount of the facsimile data up to 50 MB, the predetermined amount is 3 MB, operation 26 shown in FIG. 2 is implemented as shown in FIG. 3, a non-standard header is used as the identification factor, the facsimile data is converted into a form of TIFF in operation 46, and the facsimile document having six pages is transmitted to the network facsimile, the network facsimile operation method according to the present invention will be described. The non-standard header can be denoted by X-SamsungDivFaxMail:samsung_{—}200302221020. Here, 200302221020 shows that the data on which the facsimile data is first received to the network facsimile is 10:20 am Feb. 22, 2003.

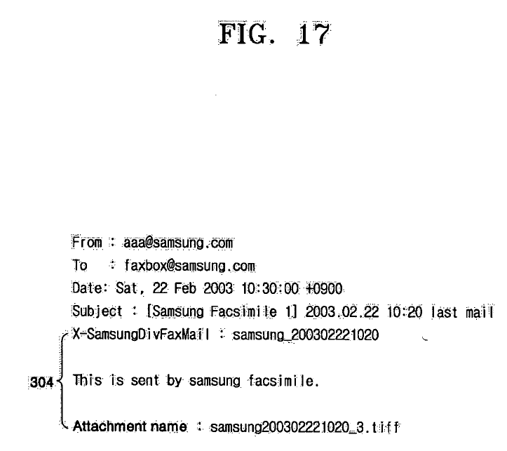

FIGS. 15-17 show forms of electronic mails into which the facsimile document is divided, and through which the facsimile document is transmitted to the mail server, wherein FIG. 15 represents a form of a first electronic mail that is first transmitted to the mail server, FIG. 16 represents a form of a second electronic mail that is second transmitted to the mail server, and FIG. 17 represents a form of a third electronic mail that is finally transmitted to the mail server. In the respective drawings, ‘From’ represents a network facsimile as a sender, ‘To’ represents a mail server designated as a receiver, ‘Date’ represents a creation date of the electronic mail, [samsung Facsimile n] in ‘subject’ as a title represents that the number of pages attached to the electronic mail is n, ‘xth mail’ represents an electronic mail x-th transmitted to the mail server, contents 300, 302, or 304 of each electronic mail includes a sentence “This is sent by samsung facsimile,” and ‘200302221020’ in a title of attached file “samsung200302221020_x.tiff” represents the date on which the facsimile data is first received by the mail server, and ‘x’ represents the order in which the electronic mail is transmitted to the mail server.

First, if it is determined that facsimile data of 1 MB is received in operation 24 when there is no printing paper, the page number n is set to “one” in operation 38. After operation 38 is performed, the received facsimile data is stored in operation 40. At this time, if the received facsimile data is an end of a first page of the facsimile document, a format of the facsimile data corresponding to the stored first page is converted in operation 46. Since the amount of the stored facsimile data of 1 MB is less than the predetermined amount of 3 MB and the facsimile data is not completely received, the page number n is changed to two and the process proceeds to operation 40 in operation 52. Then, the received facsimile data of 1 MB is stored in operation 40. After operation 40 is performed, the format of the facsimile data corresponding to the stored second page is converted operation 46. Since the amount of the stored facsimile data of 2 MB is less than the predetermined amount of 3 MB and the facsimile data is not completely received, the page number n is changed to three and the process proceeds to operation 40 in operation 52. Next, the received facsimile data of a third page with an amount of 1.5 MB is stored in operation 40. After operation 40 is performed, the format of the facsimile data corresponding to the third page is converted in operation 46. Since the amount of the stored facsimile data of 3.5 MB is greater than the predetermined amount of 3 MB, the process proceeds to operation 12. At this time, the three pages with the converted formats are made into attachments, for example, samsung200302221020_{—}1.tiff having the three pages, of the electronic mail as shown in FIG. 15, and transmitted to the mail server in operations 80 and 82. If the stored facsimile data is transmitted to the mail server, the stored facsimile data for the first through the third pages is removed.

After the first through the third pages are transmitted, if the facsimile data is not completely received and there is no printing paper, it is determined whether any facsimile data has been received in operation 24. If a fourth page of 1 MB is received, the page number n is set to “one” in operation 38. After operation 38 is performed, the received fourth page of facsimile data is stored in operation 40. At this time, if the facsimile data is the end of the page, the format of the stored fourth page of facsimile data is converted in operation 46. Since the amount of the stored facsimile data of 1 MB is less than the predetermined amount of 3 MB and the facsimile data is not completely received, the page number n is changed to two and the process proceeds to step 40 in operation 52. At this time, a received fifth page of facsimile data of 2 MB is stored in operation 40. After operation 40 is performed, the format of the facsimile data corresponding to the fifth page is converted in operation 46. Since the amount of the stored facsimile data of 3 MB is not less than the predetermined amount of 3 MB, the process proceeds to operation 12. The fourth and fifth pages with the converted formats are included as attached files, for example, samsung200302221020_{—}2.tiff having the two pages, of the electronic mail in the format shown in FIG. 16, and transmitted to the mail server in operations 80 and 82. If the stored facsimile data is transmitted to the mail server, the stored facsimile data for the fourth and the fifth pages is removed.

After the fourth and the fifth pages are transmitted, if the facsimile data is not completely received and there is no printing paper, it is determined whether any facsimile data has been received in operation 24. If a sixth page with an amount of 1 MB is received, the page number n is set to ‘one’ in operation 38. After operation 38, the received sixth page of the facsimile data is stored in operation 40. At this time, if the facsimile data of 1 MB is an end of a page, the format of the stored sixth page of facsimile data is converted in operation 46. Since the facsimile data is completely received while the amount of the stored facsimile data of 1 MB is less than the predetermined amount of 3 MB, the process proceeds to operation 12. At this time, the sixth page with the converted format is included as an attached file, i.e., samsung200302221020_{—}3.tiff having a single page, of the electronic mail shown in FIG. 17, and transmitted to the mail server on operations 80 and 82. In this case, the xth mail marked in the title is denoted as the ‘last mail’ indicating the last electronic mail. If the facsimile data corresponding to the stored sixth page is transmitted to the mail server, the stored facsimile data corresponding to the sixth page can be removed.

In FIGS. 15, 16, and 17, the identification factor is the same, so that the electronic mails corresponding to the same facsimile document can be identified as the facsimile document sent from the same network facsimile among the electronic mails to be brought later from the mail server, using the identification factor.

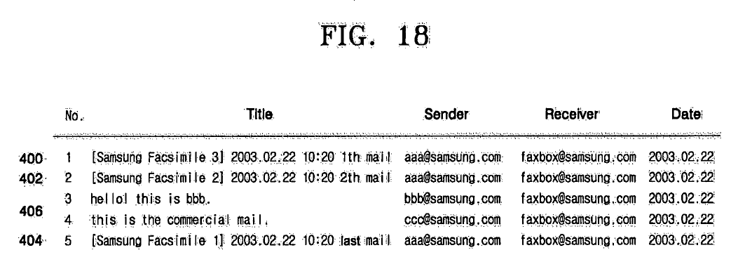

FIG. 18 shows examples of the electronic mails stored in the mail server.

As described above, after the sixth page of the facsimile document is transmitted to the mail server when there is no printing paper, if the printing paper is newly supplied, the network facsimile accesses the mail server and receives the electronic mail in operation 106. At this time, a general electronic mail 406 can or cannot be received by the network facsimile while the network facsimile receives the electronic mails 400, 402, and 404 transmitted to the mail server when there is no printing paper, among the electronic mails shown in FIG. 18. This general electronic mail 406 may be inserted into a middle of the electronic mails 400, 402, and 404 as shown in FIG. 18.

More specifically, if the printing paper is newly supplied, the network facsimile accesses the mail server and receives the header of each electronic mail in operations 120 and 122. The non-standard header is extracted as the identification factor from the received header in operation 124. At this time, the corresponding electronic mails belonging to the same facsimile document transmitted from the same network facsimile are identified using the extracted non-standard header, among the electronic mails 400, 402, 404, and 406 shown in FIG. 18, the transmission order of the corresponding electronic mails to the mail server is identified using the title, and the first transmitted electronic mail is first received and printed and the last transmitted electronic mail is last received and printed using the identified result in operation 126.

In this case, before the divided pages are printed, information, such as the total number of pages of the facsimile document, the received date and time, etc., may be printed in a form of a banner page.

As described above, according to the network facsimile and the network facsimile operation method of the present invention, it is possible to prevent a received facsimile document from being lost regardless of the received amount of the facsimile document and the storage space, by receiving and simultaneously dividing a large facsimile document into the form of an electronic mail and transmitting the divided result when there is no printing paper or the storage space to store the facsimile document is scarce, and then receiving and displaying the facsimile document from a designated mail address to a user when the printing paper is newly supplied.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A method of operating a network facsimile, the network facsimile performing both a function of transmitting and/or receiving an electronic mail to and/or from a mail server and a facsimile function, the method comprising:
storing the received facsimile data until an amount of received facsimile data is more than a predetermined amount if the facsimile data is received from an outside source when there is no printing paper on which the facsimile data is to be printed;
converting the stored facsimile data into a form of an electronic mail and transmitting the converted data to the mail server, if the amount of the received facsimile data is more than the predetermined amount or if the facsimile data is completely received; and
determining whether the facsimile data is completely received, and proceeding to the storing operation if the facsimile data is not completely received.

2. The method of claim 1, wherein the storing of storing the received facsimile data comprises:
determining whether there is the printing paper;
determining whether the facsimile data is received if it is determined that there is no printing paper, and proceeding to the determining operation whether there is the printing paper if the facsimile data is not received; and
storing the received facsimile data until the amount of the received facsimile data is more than the predetermined amount if the facsimile data is determined to be received.

3. The method of claim 2, wherein the operation of storing the received facsimile data comprises:
storing the received facsimile data if the facsimile data is received;
determining whether the facsimile data is an end of a page to be printed or whether the facsimile data is completely received, and proceeding to the operation of storing the received facsimile data if the facsimile data is not the end of the page and the facsimile data is not completely received;
determining whether the amount of the stored facsimile data is less than the predetermined amount and proceeding to the operation of converting the stored facsimile data if the amount of the stored facsimile data is more than the predetermined amount if it is determined that the facsimile data is the end of the page or if the facsimile data is completely received; and
determining whether the facsimile data is completely received if the amount of the stored facsimile data is less than the predetermined amount, proceeding to the operation of stroing the received facsimile data if the facsimile data is not completely received, and proceeding to the operation of converting the stored facsimile data if the facsimile data is completely received.

4. The method of claim 3, wherein the operation of storing the received facsimile data further comprises,
converting a format of the stored facsimile data and proceeding to the operation of determining whether the amount of the stored facsimile data is less than the predetermined amount, if the facsimile data is the end of the page or the facsimile data is completely received, and
the operation of determining whether the amount of the stored facsimile data is less that the predetermined amount comprises determining whether an amount of the converted format of facsimile data is less than the predetermined amount, proceeding to the operation of converting the stored facsimile data if the amount of the converted format of facsimile data is more than the predetermined amount, and proceeding to the operation of determining that the facsimile data is completely received if the amount of the converted format of facsimile data is less than the predetermined amount.

5. The method of claim 3, wherein the operation of storing the received facsimile data further comprises:
converting a format of the stored facsimile data and proceeding to the operation of converting the received facsimile data, if the amount of the stored facsimile data is less than the predetermined amount or if the facsimile data is completely received.

6. The method of claim 3, wherein the operation of storing the received facsimile data further comprises:
setting a page number of the facsimile data and proceeding to the operation of storing the received facsimile data if the facsimile data is received; and
increasing the page number by one and proceeding to the operation of storing the received facsimile data if the facsimile data is not completely received,
wherein in the operation of converting the stored facsimile data, the converting of the stored facsimile data into the form of the electronic mail comprises converting the facsimile data into the form of the electronic mail according to the page number.

7. The method of claim 2, wherein the operation of storing the received facsimile data comprises:
converting a format of the received facsimile data if the facsimile data is received;
storing the converted format of facsimile data;
determining whether the received facsimile data is the end of the page to be printed or the facsimile data is completely received and proceeding to the operation of converting the format of the received facsimile data if the received facsimile data is not the end of the page and the facsimile data is not completely received;
determining whether the amount of the stored facsimile data with the converted format is less than the predetermined amount if the received facsimile data is the end of the page or the facsimile data is completely received, and proceeding to operation of converting the stored facsimile data if the amount of the stored facsimile data is more than the predetermined amount; and
determining whether the facsimile data is completely received if the amount of the stored facsimile data with the converted format is less than the predetermined amount, proceeding to the operation of converting the format of the received facsimile data if the facsimile data is not completely received, and proceeding to the operation of converting the stored facsimile data if the facsimile data is completely received.

8. The method of claim 7, wherein the operation of storing the received facsimile data further comprises:
setting a page number of the facsimile data and proceeding to operation of converting the format of the received facsimile data if the facsimile data is received; and
increasing the page number by one and proceeding to the operation of converting the format of the received facsimile data if the facsimile data is not completely received,
wherein in the operation of converting the storing facsimile data, the converting of the stored facsimile data into the form of the electronic mail comprises converting of the stored facsimile data into the form of the electronic mail according to the page number.

9. The method of claim 1, wherein the operation of converting the stored facsimile data into the form of the electronic mail comprises:
converting the stored facsimile data into the form of the electronic mail if the amount of the received facsimile data is more than the predetermined amount or the facsimile data is completely received; and
transmitting the facsimile data as the form of the electronic mail to the mail server, and proceeding to the operation of determining whether the facsimile data is completely received.

10. The method of claim 9, wherein in the operation of converting the stored facsimile data, the electronic mail comprises an identification factor to identify the facsimile data.

11. The method of claim 10, wherein the electronic mail comprises a standard or a non-standard header which includes the identification factor.

12. The method of claim 10, wherein the electronic mail comprises a title which includes the identification factor.

13. The method of claim 10, the method further comprising:
determining whether printing paper is newly supplied after there is no printing paper;
determining whether the electronic mail transmitted to the mail server when there is no printing paper exists, if the printing paper is newly supplied after there is no printing paper; and
receiving and displaying the electronic mail from the mail server, if the electronic mail transmitted to the mail server exists.

14. The method of claim 13, wherein the operation of receiving and displaying the electronic mail comprises:
accessing the mail server if the electronic mail transmitted to the mail server exists;
receiving a header from the accessed mail server;
extracting the identification factor from the header; and
perceiving the electronic mail belonging to the same facsimile document among the electronic mails divided and transmitted to the mail server and receiving the perceived electronic mail from the mail server, using the extracted identification factor, and showing the received electronic mail to the user.

15. The method of claim 1, further comprising:
determining whether a new printing paper is supplied after it is determined that there is no the printing paper;
determining whether the electronic mail transmitted to the mail server exists when it is determined that there is no printing paper, if the new printing paper is supplied after it is determined that there is no printing paper; and
receiving and displaying the electronic mail from the mail server if the electronic mail transmitted to the mail server exists.

16. The method of claim 15, wherein the operation of storing the received facsimile data comprises setting a state indicating that there is no printing paper when it is determined that there is no printing paper, performing the operation of determining that the new printing paper is supplied when there is printing paper and determines whether the state is set, and the method further comprises releasing the state if the state is set, and proceeding to the operation of determining that the electronic mail transmitted to the mail server exists.

17. The method of claim 15, wherein the operation of determining whether the electronic mail transmitted to the mail server exists further comprises searching for the mail server and determining whether the electronic mail transmitted to the mail server exists when there is no printing paper.

18. The method of claim 9, further comprising:
determining whether a new printing paper is supplied after it is determined that there is no printing paper;
determining whether the electronic mail transmitted to the mail server exists when it is determined that there is no printing paper, if the new printing paper is supplied after it is determined that there is no printing paper; and
receiving and displaying the electronic mail from the mail server is the electronic mail transmitted to the mail server exists.

19. The method of claim 18, wherein the operation of converting the stored facsimile data into the format the electronic mail further comprises setting a variable indicating that the facsimile data is transmitted as the form of the electronic mail to the mail server, and proceeding to the operation of determining that the facsimile data is completely received,
wherein in the operation of determining that the electronic mail transmitted to the mail server exists, it is determined whether the variable is set if the new printing paper is supplied after there is no printing paper,
wherein in the operation of receiving and displaying the electronic mail from the mail server, the electronic mail is received from the mail server if the variable is set, and the received electronic mail is provided to the user, and
wherein the method further comprises resetting the variable after the operation of receiving and displaying the electronic mail is performed.

20. A network facsimile performing both a function of transmitting/receiving an electronic mail to/from a mail server and a facsimile function, the network facsimile comprising:
a data receiving processor, which checks whether a printing paper to print facsimile data provided from an outside source exists, whether the facsimile data is received, whether an amount of the received facsimile data is more than a predetermined amount, and whether the facsimile data is completely received, to generate first, second, third and fourth control signals, respectively, receives and stores the facsimile data in response to first, second, third, and fourth control signals, and outputs the stored facsimile data in response to one of the third and fourth control signal; and
a data transmitting processor, which converts the stored facsimile data received from the data receiving processor into a form of the electronic mail and transmits the converted data to the mail server.

21. The network facsimile of claim 20, wherein the data receiving processor comprises:
a paper check unit, which checks whether there is the printing paper, in response to the second control signal and outputs the checked result as the first control signal;
a data receipt check unit, which checks whether the facsimile data is received, in response to the first control signal, and outputs the checked result as the second control signal;
a data management unit, which stores and manages the received facsimile data, in response to the second control signal.

22. The network facsimile of claim 21, wherein the data management unit comprises:
a first page check unit, which checks whether the received facsimile data is an end of a page to be printed and outputs the checked result as fifth control signal;
a first data storage unit, which stores the received facsimile data, in response to one of the second control signal, the fourth control signal, and the fourth and fifth control signals, and reads the stored facsimile data in response to one of the third and fourth control signal;
a first amount comparison unit, which compares an amount of the stored facsimile data received from the first data storage unit with the predetermined amount in response to the fourth and the fifth control signals, and outputs the comparison result as the third control signal; and
a first receiving completion check unit, which checks whether the facsimile data is completely received, in response to one of the third and fifth control signal, and outputs the checked result as the fourth control signal.

23. The network facsimile of claim 22, wherein the data management unit further comprises:
a first format converter, which converts a format of the stored facsimile data in response to one of the fourth and fifth control signals, outputs the converted format of the facsimile data to the first amount comparison unit, and outputs the converted format of the facsimile data to the data transmitting processor in response to the third and fourth control signals,
wherein the first amount comparison unit compares the amount of the converted format of the facsimile data with the predetermined amount.

24. The network facsimile of claim 22, wherein the data management unit further comprises:
a page number generator, which sets a page number of the received facsimile data in response to the second control signal, and increases the page number by one in response to the third and fourth control signals,
wherein the data transmitting processor constructs the form of the electronic mail according to the page number.

25. The network facsimile of claim 21, wherein the data management unit comprises:
a second format converter, which converts a format of the received facsimile data, in response to one of the second control signal, the third and fourth control signals, and the fourth and fifth control signals;
a second data storage unit, which stores the converted format of the facsimile data received from the second format converter, and reads the stored facsimile data in response to one of the third and fourth control signals;
a second page check unit, which checks whether the facsimile data is the end of the page to be printed, and outputs the checked result as the fifth control signal;
a second receiving completion check unit, which checks whether the facsimile data is completely received, in response to one of the third and fifth control signal, and outputs the checked result as the fourth control signal; and
a second amount comparison unit, which compares the amount of the stored facsimile data received from the second data storage unit with the predetermined amount in response to both the fourth and fifth control signals or only the fifth control signal, and outputs the compared result as the third control signal.

26. The network facsimile of claim 20, wherein the data transmitting processor comprises:
an electronic mail generator, which converts the stored facsimile data received from the data receiving processor into the form of the electronic mail; and
a data transmitter, which transmits the facsimile data in the form of the electronic mail received from the electronic mail generator to the mail server.

27. The network facsimile of claim 26, further comprising:
a paper check unit, which supplies printing paper after it is determined that there is no printing paper, and outputs the checked result as a sixth control signal;
a transmission mail check unit, which checks whether the electronic mail transmitted to the mail server when it is determined that there is no printing paper, exists, in response to the sixth control signal, and outputs the checked result as a seventh control signal; and
a mail receiving and displaying unit, which receives and displaying the electronic mail from the mail server in response to the seventh control signal.

28. The network facsimile of claim 27, wherein the data transmitting processor further comprises,
a variable setting unit, which sets a variable indicating that the facsimile data in the form of the electronic mail is transmitted to the mail server, in response to transmission completion of the facsimile data from the data transmitter, resets the variable in response to display completion from the mail receiving and displaying unit, and outputs the variable to the transmission mail check unit,
wherein the transmission mail check unit checks whether the variable is set, and outputs the checked result as the seventh control signal.

29. The network facsimile of claim 26, wherein the electronic mail generator converts the facsimile data into the form of the electronic mail so that the electronic mail includes an identification factor to identify the facsimile data.

30. The network facsimile of claim 29, further comprising:
a paper check unit, which checks whether a new printing paper is supplied after it is determined that there is no printing paper, and outputs the checked result as a sixth control signal;
a transmission mail check unit, which checks whether the electronic mail transmitted to the mail server when it is determined that there is no printing paper, exists, in response to the sixth control signal, and outputs the checked result as a seventh control signal; and
a mail receiving and displaying unit, which receives and displays the electronic mail from the mail server in response to the seventh control signal.

31. The network facsimile of claim 30, wherein the mail receiving and displaying unit comprises:
a header receiver, which accesses the mail server and receives a header from the mail server in response to the seventh control signal;
a factor extraction unit, which extracts the identification factor from the header;
a mail receiver, which identifies the electronic mail belonging to the same facsimile document that has been divided and transmitted to the mail server, using the extracted identification factor, and receives the identified electronic mail from the mail server; and
a display unit, which displays the electronic mail received from the mail receiver.

32. The network facsimile of claim 20, further comprising:
a paper check unit, which checks whether a new printing paper is supplied after it is determined that there is no printing paper and outputs the checked result as a sixth control signal;
a transmission mail check unit, which checks whether the electronic mail transmitted to the mail server when it is determined that there is no printing paper, exists, in response to the sixth control signal, and outputs the checked result as a seventh control signal; and
a mail receiving and displaying unit, which receives and displays the electronic mail from the mail server, in response to the seventh control signal.

33. The network facsimile of claim 32, wherein:
the data receiving processor generates a state signal indicating that there is no printing paper when it is determined that there is no printing paper;
the a paper check unit checks whether the state signal is generated, in response to the first control signal, and outputs the check result as the sixth control signal;
the network facsimile further comprises a state release unit which generates an eighth control signal to stop the generation of the state signal in response to the sixth control signal;
the data receiving processor stops generating the state signal in response to the eighth control signal; and
the transmission mail check unit checks whether the electronic mail transmitted to the mail server when it is determined that there is no printing paper, exists, in response to the eighth control signal.

34. The network facsimile of claim 32, wherein the transmission mail check unit searches for the mail server and generates the seventh control signal in response to the sixth control signal.
